(19) United States
(12) Patent Application Publication
(10) Pub. No.: US 2001/0041598 A1
(43) Pub. Date: Nov. 15, 2001

(54) Mobile communication device

(75) Inventors: Tatsuya Yoshino, Yokosuka-shi (JP); Atsushi Inoue, Yokohama-shi (JP)

Correspondence Address: Motorola, Inc., Personal Communication Sector, Intellectual Property Department (LPW), 600 North US Highway 45, Rm. AN475, Libertyville, IL, 60048, US

(73) Assignee: MOTOROLA, INC.

(21) Appl. No.: 09/732,441

(22) Filed: Dec. 7, 2000

(30) Foreign Application Priority Data
Dec. 20, 1999 (JP) 11-360426

(51) Int. Cl. H04B 1/38

(52) U.S. Cl. 455/566; 455/550; 455/575; 455/90

(57) ABSTRACT

A mobile communication device that permits a pointer on a display to be moved in a easy-to-use, flexible manner. A display 12 is disposed on the front face of a mobile communication device 10, while a pointing device 22 is placed on the rear face thereof. As the user manipulates the pointing device 22 by his or her finger, a pointer 16 on the display 12 may be moved, and an item presented on the display can also be selected and confirmed by tapping the pointing device.

### TECHNICAL FIELD

The present invention relates generally to mobile communication devices with a display on a front face thereof. More specifically, the present invention relates to a mobile communication device having a pointing device on a rear face thereof that can be manipulated by the user's finger so that a pointer presented on the display moves in response to the operation of the pointing device.

### BACKGROUND OF THE INVENTION

Recently, mobile communication devices, such as cellular phones and PHS (personal handyphone system) handsets, are rapidly gaining popularity. A mobile device of this type has a relatively large display on its front face so that functional information, such as features of the mobile device, and personal information, such as an address book, can be displayed. It may be not only used as a telephone but also as used to send and receive e-mails and faxes and to access World Wide Web (WWW) sites via the Internet to browse home pages.

The device makes a telephone call through numeric keys, and additionally retains address book data internally so that a telephone call can be originated based on the telephone number of the called party selected from the address book, without keying in that telephone number. Thus, it might be convenient to use a pointer on the display to indicate telephone numbers on the display, scroll them, and select a desired one of the displayed telephone numbers before initiating a call.

On the other hand, home page information obtained from a WWW server is described in Hypertext Markup Language (HTML). A HTML-described document itself is a text file, where text style, layout, and other information is specified by codes placed between symbols called tags, which are parsed by a program, called a browser, to visually present the HTML document.

HTML documents not only permit other texts, images, audios to be embedded in those documents, but also allow portions of a given HTML document to be linked to images and other HTML documents. More specifically, in a HTML document, by linking (associating) a position within the same document (i.e., an anchor point or hot spot) to another position or another file, etc., the viewer can immediately jump from one position to another linked position, so that he or she can navigate documents very efficiently and flexibly. Additionally, in accordance with the selection of an anchor point, the viewer can open a window for sending an e-mail or activate a certain function associated with that anchor point.

In this way, by setting anchor points for various items in HTML documents, the user can merely select those anchor points to navigate the documents in response to those anchor points and perform various functions associated therewith.

Some mobile communication devices have a pen that serves as a pointing device to give direct instructions to the touch panel disposed on the screen of the display. However, the pen may be easily lost, and it may be cumbersome to utilize the pen whenever the device is to be used.

Additionally, some devices use arrow keys on the front face to provide two-way directions. However, the arrow keys occupy the real estate of the mobile communication device and thus hamper the current pursuit of smaller sizes of such devices, so that free two-dimensional movement of the pointer cannot always be achieved.

In light of the above considerations, the present invention is intended to overcome the above-described problems and improve the usability of the mobile communication device.

### BRIEF DESCRIPTION OF THE DRAWINGS

FIG. 1 is a front view of a mobile phone according to one embodiment of the present invention.

FIG. 2 is a rear view of the mobile phone shown in FIG. 1.

FIG. 3 is a side view of the mobile phone shown in FIG. 1.

FIG. 4 is a block diagram illustrating the operation that causes the operation of the pointing device of the mobile phone shown in FIG. 1 to be reflected on the display.

### DETAILED DESCRIPTION OF THE PREFERRED EMBODIMENT

One embodiment of the present invention is described below with reference to the drawings. FIG. 1 shows how a mobile phone 10, one example of a mobile communication device, is held by a user's hand. The mobile phone 10 according to the present embodiment is a candy-bar-type phone, but may be a phone of flip type or other types. On the front face of the mobile phone 10 are disposed a display 12 and a keypad 14. The display 12 may be of any type, such as a liquid crystal (LCD), LED and flat-panel displays. On the display, functional information of the mobile phone 10 or address-book information may be displayed, and when accessing the Internet, information about the home page or e-mail may also be presented. To select one of these information items or anchor point, a pointer 16 is used which may be moved across the display. To move this pointer or highlight (select) and confirm an item, a pointing device is used, which is described hereinbelow.

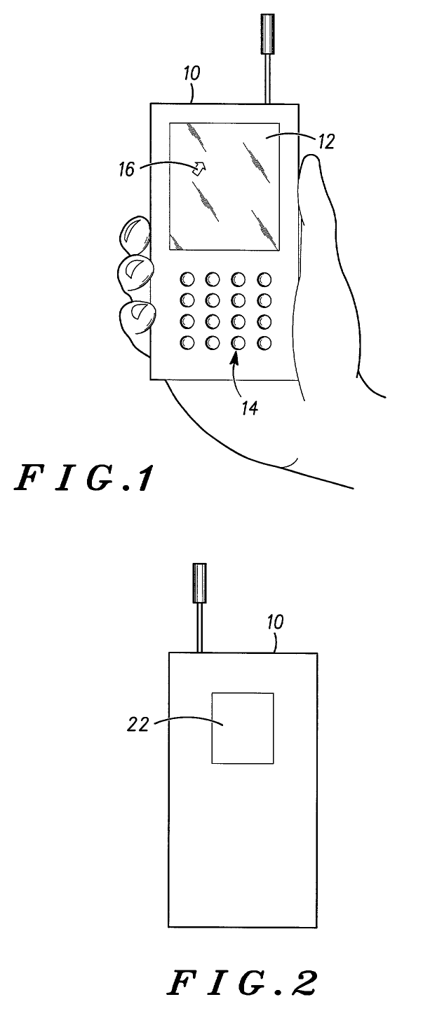

FIG. 2 is a rear view of the mobile phone 10, where a touch pad 22, one example of the pointing device, is shown in the upper middle portion thereof. For a flip-type phone, the touch pad 22 may be disposed on the main body or the rear side of the flip portion. If the battery is located on the rear side, the touch pad may be disposed over the battery. As the touch pad 22, an electrostatic touch pad or piezoelectric touch pad is suitable, although any type of touch pad may be acceptable as far as it may be manipulated by the user's finger. Furthermore, a finger-manipulable trackball may also be used as the pointing device.

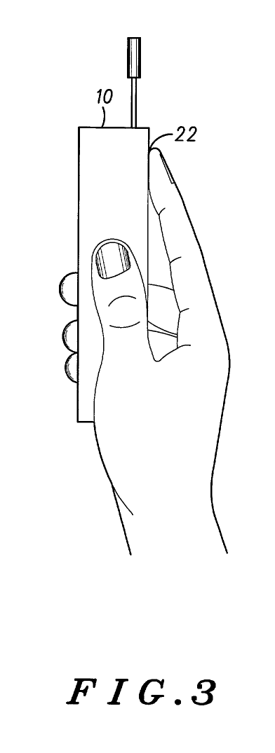

As shown in FIG. 3, by moving the forefinger of the hand that holds the mobile phone, for example, while bringing it into contact with the touch pad 22, the pointer on the display 12 may be moved in response thereto. After the pointer 16 has moved onto a desired item or anchor point, the operator may lightly hit (tap) the touch pad 22 by his or her forefinger to highlight and select the item. By tapping it twice, the item may be ultimately selected and confirmed. These operations are well known to those of ordinary skill in the art, and thus are not further described in detail. In this way, by manipulating the touch pad, the operator can flexibly select the mode, function, item, anchor point, and so forth on the display. Because the forefinger may be moved freely over the touch pad, the pointer may be allowed an unfettered, two-dimensional movement.

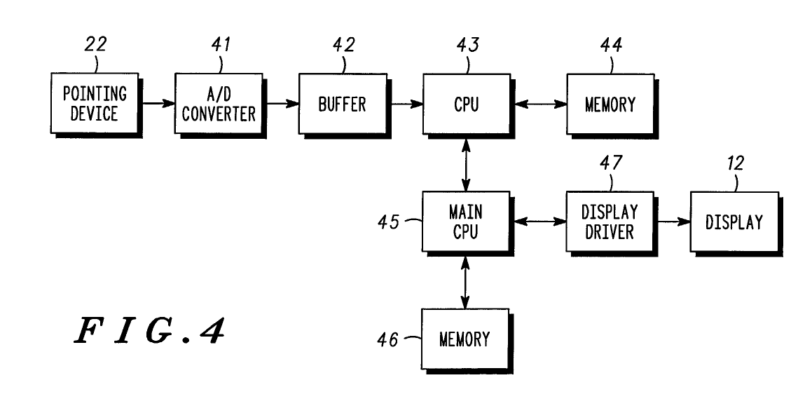

FIG. 4 is a block diagram, which illustrates the circuit configuration for moving the pointer on the display by manipulating the pointing device 22. Analog data that represents the movement of the forefinger over the pointing device 22 is converted by an analog-to-digital (A/D) converter 41 to digital data, which is provided via a buffer 42 to a central processing unit (CPU) 43. A main CPU 45 performs a predetermined process according to the data from the CPU 43 to drive a display driver 47, thereby allowing the pointer to move on the display 12. Data corresponding to the tapping action over the pointing device 22 is also similarly provided to the main CPU 45 to permit an item to be highlighted, selected, and confirmed. These operations are well known to those of ordinary skill in the art, and thus are not further described in detail.

According to the present invention so configured, the user can move a pointer on the display and select an item, while holding the mobile phone single-handedly. Furthermore, the fact that functions keys and so forth that would be located on the front surface are no longer used contributes to a smaller size of the device. Because the pointing device, such as the touch pad, has no movable part, it can improve durability and reliability. By moving the forefinger over the area just behind the display, the pointer appears as if it would directly follow the movement of the forefinger; thus, pointer movement feels so intuitive that good usability can be achieved.

What is claimed is:

1. A mobile communication device comprising:
a body having at least a first face and a second face, the second face opposite to the first face;
a display disposed on the first face, for displaying selection items; and
a pointing device disposed on the second face, the pointing device being manipulable by a user's finger;
wherein a pointer displayed on the display moves in response to the manipulation of the pointing device to permit the selection items to be selected.

2. The mobile communication device according to claim 1, wherein:
said mobile communication device is a mobile phone.

3. The mobile communication device according to claim 1, wherein:
said display is a liquid crystal display.

4. The mobile communication device according to claim 1, wherein:
said pointing device is a piezoelectric touch pad.

5. The mobile communication device according to claim 1, wherein:
said pointing device is an electrostatic touch pad.

6. The mobile communication device according to claim 1, wherein:
said pointing device is a trackball.

7. The mobile communication device according to claim 1, wherein:
said selection items comprise functional information.

8. The mobile communication device according to claim 1, wherein:
said selection items comprise personal information.

9. The mobile communication device according to claim 1, wherein:
said pointing device may be tapped while the pointer is placed on a selection item, thereby allowing the selection item to be selected.
